(19) United States
(12) Patent Application Publication
(10) Pub. No.: US 2009/0220126 A1
(43) Pub. Date: Sep. 3, 2009

(54) PROCESSING AN IMAGE OF AN EYE

(75) Inventors: Frederic Vladimir Claret-Tournier, Brighton (GB); Christopher Reginald Chatwin, Hove (GB); David Rupert Charles Young, Brighton (GB); Karlis Harold Obrams, Leeds (GB)

Correspondence Address: SHERIDAN ROSS PC, 1560 BROADWAY, SUITE 1200, DENVER, CO, 80202, US

(73) Assignee: XVISTA BIOMETRICS LIMITED, Leeds (GB)

(21) Appl. No.: 12/280,145

(22) PCT Filed: Feb. 21, 2007
(86) PCT No.: PCT/GB07/00591

§ 371 Date: Dec. 9, 2008

(30) Foreign Application Priority Data
Feb. 21, 2006 (GB) 0603411.0

(51) Int. Cl. G06K 9/00; G06K 9/48

(52) U.S. Cl. 382/117; 382/199; 382/170

(57) ABSTRACT

An image of an eye is first captured and stored, as a 256 grey level image or as a colour image, and is then evaluated to determine thresholds between the values of pixels representing different parts of the eye. The thresholds are used to determine the boundary between the pupil and the iris and the boundary between the iris and the selera by determining the points at which lines across the image change their value with respect to a threshold value. Once the location of the iris has been found, the image is further processed to extract a biometric code from the iris using a linearisation procedure followed by a wavelet transformation. Finally, a biometric code is output by the processor.

### FIELD OF THE INVENTION

This invention relates to processing an image of an eye, typically to facilitate personal identification techniques based on characteristics of the iris. In particular, it relates to locating the iris in a pixel-based image of an eye and to generating a code based on the appearance of the iris from the image.

### BACKGROUND TO THE INVENTION

Digital image processing techniques generally require substantial computing power. For example, filtering a pixel-based image using an N×M mask requires in the computation of N×M multiplications and N×M additions for each pixel of the image. For a typical Video Graphics Array (VGA) image, having a standard resolution of 480×640 pixels, and a 5×5 filtering mask, the number of operations may therefore be 2×5×5×480×640=1.5×10⁷. In the case of a Fourier transform of the input image, the number of operations can be reduced to N²×log(N) for an N×N image and this number of operations may be acceptable when powerful personal computers (PCs) or purpose-built digital signal processors (DSPs) are employed to perform the calculations, but when smaller handheld computing devices, such as Personal Digital Assistants (PDAs) or mobile telephones are being used, image processing can often not be achieved in a useful timeframe.

There is increasing interest in the use of the human iris for identification purposes. However, the techniques that have so far been suggested for processing images of eyes to facilitate such identification purposes are computationally complex. More specifically, they tend to rely on algorithms that process the entire image in two dimensions, resulting in the levels of computational complexity outlined above.

For example, due to the geometry of the iris and the pupil, the Hough transform is often used to detect the centres of both the iris and the pupil. This transform and the curves detected are extremely computationally intensive. Similarly, in U.S. Pat. No. 5,291,560 an iris is found in an image of an eye by looking at the summed brightness of a number of concentric circles in the image. Again, this method is computationally complex. Similarly, once the iris has been located, a group of algorithms known as the Daugman algorithms is often used to transform the iris image data into a biometric code. Again, the Daugman algorithms are known to be computationally complex.

So, up to know, biometric identification systems that use the human iris have only been implemented using devices that have significant processing power. It has not been possible to implement these systems on PDAs or mobile telephones, for example. This is unfortunate, as there are many potential situations in which it would be useful to implement such identification systems on mobile devices. It should also be noted that, as the power consumed by a processor increases rapidly with processing speed, it is unlikely that sufficient processing power will soon be made available in mobile devices (that rely on batteries for power) to implement identification systems using conventional image processing techniques. So, it remains difficult to see how iris identification system can be implemented on mobile devices. Likewise, efficient methods of processing an image of an eye for identification purposes remain unavailable.

The present invention seeks to overcome these problems.

### SUMMARY OF THE INVENTION

According to a first aspect of the present invention, there is provided a method of locating a boundary of an iris in a pixel-based image of an eye, the method comprising: comparing the values of each of a number of pixels along a plurality of lines across the image with a first threshold value in order to detect points along the lines at which the values of the pixels change to indicate the boundary of the iris of the eye; and locating the boundary on the basis of the detected points.

According to a second aspect of the present invention, there is provided an apparatus for locating a boundary of an iris in a pixel-based image of an eye, the apparatus comprising a processor that: compares the values of each of a number of pixels along a plurality of lines across the image with a first threshold value in order to detect points along the lines at which the values of the pixels change to indicate the boundary of the iris of the eye; and locates the boundary on the basis of the detected points.

This allows significantly more computationally efficient location of the iris in an image. Processing of only simple lines of pixels is required, using only a small number of operations. This makes the implementation on a mobile phone or such like a more realistic prospect.

The invention uses a pixel-based technique. The comparison is usually carried out on a pixel by pixel basis. That is, the comparison may comprise scanning along the lines. Each pixel along each line may be compared to the threshold value.

Preferably, the invention includes: comparing the values of each of a number of pixels along a primary line across the image with the first threshold value in order to locate a primary point along the primary, line at which the values of the pixels change to indicate the boundary of the iris of the eye; comparing the values of each of a number of pixels along a secondary line across the image with the first threshold value in order to locate a point along the secondary line at which the values of the pixels change to indicate the boundary of the iris of the eye; and locating the boundary on the basis of the detected primary and secondary points

In one example, the secondary line passes through the primary point. Indeed, it may start from the primary point. The secondary line may be perpendicular to the primary line. Alternatively, the secondary line may be around 45° to the primary line. Usually, multiple secondary points are detected using multiple such secondary lines. This tends to allow efficient identification of multiple points around the boundary of the iris.

The invention preferably also includes verifying that the primary and secondary points reside substantially on a circle. It may include identifying the centre of a circle defined by the primary and secondary points.

The invention may include locating another boundary of the iris by comparing the values of each of a number of pixels along a plurality of lines across the image with a second threshold value in order to detect points along the lines at which the values of the pixels change to indicate the boundary; and locating the boundary on the basis of the detected points.

The first threshold value may be a maximum value of the pupil. The second threshold may be a mode value for the iris. Alternatively, the second threshold may be a maximum value for the iris or an average of the mode value for the iris and the maximum value for the iris.

The invention may include identifying a pixel along the lines at a exit of a shadow zone of the image by comparing the values of the pixels to a third threshold value and locating a start for the comparison to the first threshold value at the identified point. The third threshold value may be the mode value for the iris. Alternatively, the third threshold value may be the maximum value for the iris.

Usually, the image is evaluated to determine the threshold value(s). The evaluation might comprise determining the threshold value(s) from a distribution of pixel values in at least part the image. Usually, the evaluation comprises calculating a histogram of pixel values for at least part of the image. In most examples, the values are levels of brightness.

The invention extends to generating a code based on the appearance of the iris in the image by: identifying an area of the image representing the iris from the located boundary/ies; generating a signal comprising values of a line of pixels extending around in a circumferential portion of the identified area; and applying a wavelet filter to the signal to generate a frequency limited code based on the appearance of the iris.

Indeed, this is considered new in itself and, according to a third aspect of the present invention, there is provided a method of generating a code based on the appearance of an iris in a pixel-based image of an eye, the method comprising: identifying an area of the image representing the iris; generating a signal comprising values of a line of pixels extending around in a circumferential portion of the identified area; and applying a wavelet filter to the signal to generate a frequency limited code based on the appearance of the iris.

Similarly, according to a fourth aspect of the present invention, there is provided an apparatus for generating a code based on the appearance of an iris in a pixel-based image of an eye, the apparatus comprising a processor that: identifies an area of the image representing the iris; generates a signal comprising values of a line of pixels extending around in a circumferential portion of the identified area; and applies a wavelet filter to the signal to generate a frequency limited code based on the appearance of the iris.

The wavelet filter is usually a Haar filter. The code is usually a Tri-state code in which one state represents an invalid section of the code.

Expressed differently, according to a fifth aspect of the present invention there is provided a method of processing a pixel-based image of an eye comprising the steps of:

acquiring a pixel-based image of an eye;

evaluating the image to determine thresholds representing features of the eye;

scanning along a predetermined line and comparing with a first predetermined threshold so as to determine a first point at the boundary of the pupil;

conducting further scans in a plurality of predetermined directions from the first point so as to determine a plurality of second points at the boundary of the pupil and the iris;

identifying the centre of the pupil on the basis of the first and second points;

scanning along a further predetermined line and comparing with a second predetermined threshold so as to determine a third point at the boundary of the iris and the sclera; and dividing the iris into a plurality of concentric zones and processing each zone in turn to produce a linear signal of predetermined length.

The image may be evaluated to determine three thresholds, a first threshold representing the iris mode value, a second threshold representing a minimum value for the iris and a maximum value for the pupil, and a third threshold representing a maximum value for the iris and a minimum value for the sclera. The first predetermined threshold may be the second threshold. The second predetermined threshold may be the average value of the first and third thresholds.

The image may be evaluated with the aid of a histogram. The data in the histogram may be smoothed, for example by decomposing the histogram into its wavelet coefficients. Part only of the original image may be evaluated.

The method may include the further step, prior to determining the first point, of determining whether a pixel has a value above a third predetermined threshold, moving to the next pixel if the value is not above the third predetermined threshold and repeating the test, moving to the next pixel if the value is above the third predetermined threshold and determining whether a predetermined number of sequential pixels are above the third predetermined threshold so as to establish whether any shadow zone has been exited. The third predetermined threshold may be the first or the third threshold.

Scanning for the determination of the first point may be conducted in relation to a grid pattern, the grid pattern having horizontal, vertical and diagonal lines.

The step of scanning for the first point may comprise comparing with the first predetermined threshold and, if the pixel has a value not less than the first predetermined threshold, moving to the next pixel, and, if the pixel has a value less than the first predetermined threshold, moving to the next pixel and determining that the boundary of the pupil has been located if the next pixel also has a value less than the first predetermined threshold. The first predetermined threshold may be the second threshold.

The step of scanning for the first point may include scanning for a plurality of first points. In such a case, further scans may be conducted for each first point.

The further scan may be conducted in four directions. The four directions may be horizontal, vertical and +/−45 degrees to the horizontal (or vertical).

The further predetermined line may start from the centre of the pupil. A plurality of further predetermined lines may be scanned and the edge of the iris may be determined by a best fit circle through the corresponding third points.

In the event the iris is not annular, the first second and third points may be compared with stored data and the determined data may be translated to equate to a substantially annular form for dividing into a plurality of concentric zones.

The concentric zones may be processed with a wavelet filter, in particular a Haar wavelet filter. The concentric zones may then be processed with an averaging filter, a Gaussian filter or a wavelet filter, such as a further Haar filter, to produce a one-dimensional signal.

The signal from each concentric zone may then be resampled to produce a signal of predetermined length and the resampled signal may be filtered along its length with a wavelet filter, such as a Haar filter to produce a biometric code.

The biometric code may be a tri-state code incorporating a third state representing data that is not to be used during authentication. The biometric code may be converted into a hash function.

Use of the term “processor” above is intended to be general rather than specific. The invention may be implemented using an individual processor, such as a digital signal processor (DSP) or central processing unit (CPU). Similarly, the invention could be implemented using a hard-wired circuit or circuits, such as an application-specific integrated circuit (ASIC), or by embedded software. Indeed, it can also be appreciated that the invention can be implemented using computer program code. According to a further aspect of the present invention, there is therefore provided computer software or computer program code adapted to carry out the method described above when processed by a processing means. The computer software or computer program code can be carried by a computer readable medium. The medium may be a physical storage medium such as a Read Only Memory (ROM) chip. Alternatively, it may be a disk such as a Digital Versatile Disk (DVD-ROM) or Compact Disk (CD-ROM). It could also be a signal such as an electronic signal over wires, an optical signal or a radio signal such as to a satellite or the like. The invention also extends to a processor running the software or code, e.g. a computer configured to carry out the method described above.

For a better understanding of the present invention and to show more clearly how it may be carried into effect, preferred embodiments of the invention are described below, by way of example only, with reference to the accompanying drawings.

### BRIEF DESCRIPTION OF THE DRAWINGS

FIG. 1 is a schematic illustration of a mobile telephone for acquiring an image representing a human eye;

FIG. 2 illustrates a camera arrangement of the mobile telephone shown in FIG. 1 for acquiring the image of the human eye;

FIG. 3 is a flow chart illustrating the basic steps employed according to the present invention to derive unique biometric data from an image of a human eye;

FIGS. 4A to 4D illustrate histograms of the brightness of an image of the human eye, with FIGS. 4B and 4D being smoothed versions of FIGS. 4A and 4C respectively;

FIG. 5 is a flow chart illustrating the steps involved in determining peaks and thresholds in the histograms shown in FIGS. 4A to 4D;

FIG. 6 illustrates the use of a frame within the overall image;

FIG. 7 is a flow chart illustrating the steps involved in identifying dark zones of an image;

FIG. 8 is a flow chart illustrating the steps involved in identifying whether a pixel of the image is within a dark zone that may be a pupil of an eye;

FIG. 9 illustrates a procedure for determining the diameter of a pupil;

FIG. 10 illustrates the pupil of a horse eye and the directions of dilation thereof;

FIG. 11 illustrates the pupil of a cat eye and the directions of dilation thereof;

FIG. 12 illustrates the division of the iris into a plurality of concentric zones;

FIG. 13 illustrates the processing of image data representing an iris with a Haar filter;

FIG. 14 illustrates the steps involved in calculating a Hamming distance in the image data representing an iris; and

FIGS. 15 and 16 illustrate the effect of eye rotation on the analysis of a code based on the appearance of an iris.

### DETAILED DESCRIPTION OF THE PREFERRED EMBODIMENTS

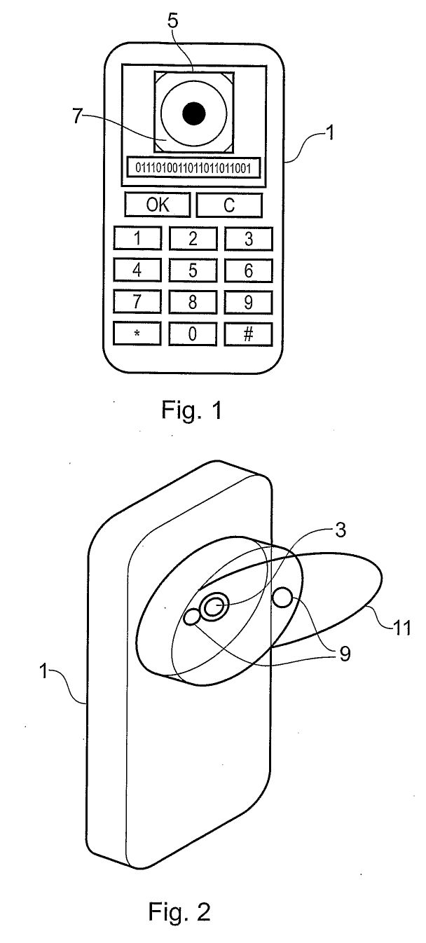

Referring to FIGS. 1 and 2, a mobile telephone 1 is equipped with a camera 3 and a display 5. The camera 3 can be used to capture an image 7 of a human or animal eye that can be shown on the display 5. In this embodiment, the camera 3 has a stand-off cup 11 for positioning a subject's eye during image capture. The stand-off cup 11 is arranged to position the eye of the subject such that it is in the focus of the camera 3.

The stand-off cup 11 is made from a material that blocks ambient light and the camera 3 has two LEDs 9 for providing illumination inside the cup 11. The LEDs 9 provide a known and controllable source of light, with the result that the eye is adequately illuminated during image capture. In the illustrated embodiment, the LEDs 9 provide substantially white light.

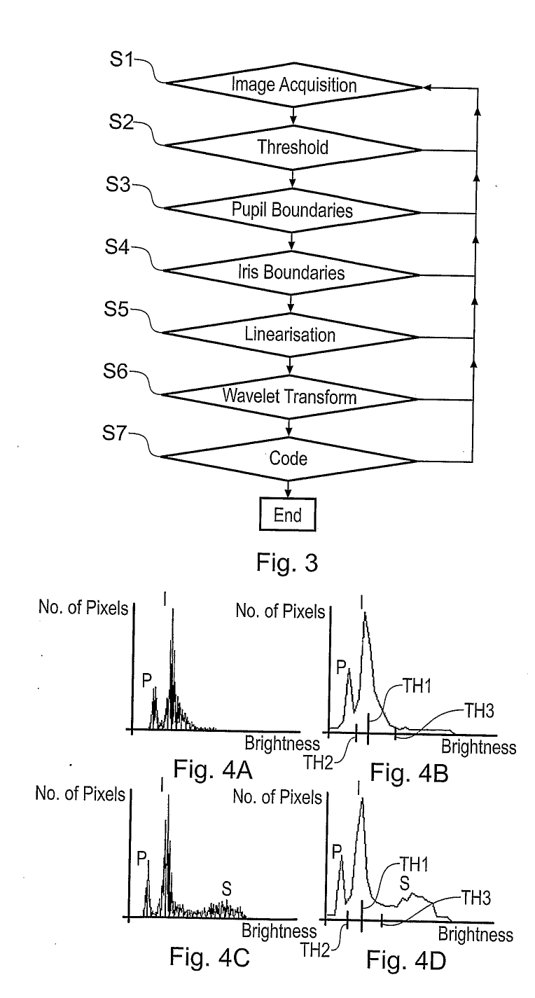

Once an image of the eye has been captured by the camera 5, the captured image is stored in a memory (not shown) of the mobile telephone 1 for further analysis. More specifically, a processor (not shown) of the mobile telephone 1 processes the image to derive unique biometric data from the image, as illustrated in FIG. 3. If any of the criteria required of the captured image, such as focussing and illumination, are not met, a further image is captured and the processing started again.

The image is first captured and stored at step S1, as a 256 grey level image or as a colour image, and is then evaluated at step S2 to determine thresholds between the values of pixels representing different parts of the eye, that is between the pupil, the iris and the sclera. The thresholds are used to determine the inner and outer boundaries of the iris, that is the boundary between the pupil and the iris at step S3 and the boundary between the iris and the sclera at step S4. Once the location of the iris has been found, the image is further processed to extract a biometric code from the iris using a linearisation procedure at step S5 followed by a wavelet transformation at step S6. Finally, a biometric code is output by the processor at step S7.

Referring to FIGS. 4A to 4D, the thresholds are determined using a histogram of pixel values found in the image. When the image is stored as a 256 grey level image, the histogram is calculated using grey scale levels. When the image is stored as a colour image, the histogram is calculated using individual red (R), green (G) or blue (B) components of the pixels of the image (or a combination of the RGB components). A typical histogram of brightness values, such as those shown in FIGS. 4A and 4C, shows two or three peaks which are relatively close to each other. One peak, labelled P in the drawings, relates to the brightness values of the pixels representing the pupil. The other peak or peaks relate to the values of the pixels representing the iris and sclera respectively and are labelled I and S in the drawings. So, the peaks correspond with the three main zones usually found in an image of the eye: a dark central zone representing the pupil; a medium annular zone representing the iris; and a light outer zone representing the sclera. For dark irises, the difference in brightness between pupil pixel values and iris pixel values can be relatively small. Nonetheless, it is possible to identify thresholds between the pixel values for the different zones.

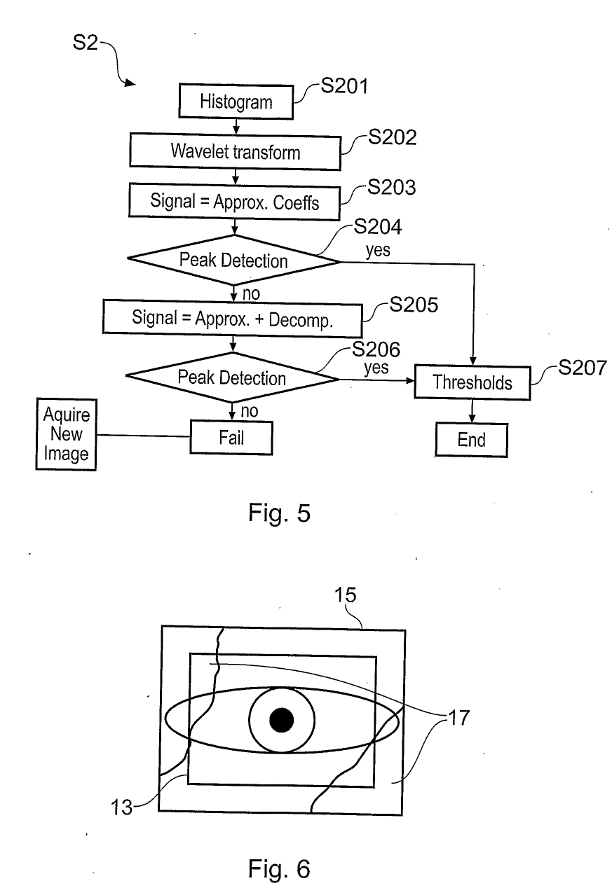

More specifically, referring to FIG. 5, after the histogram is first calculated at step S201, a signal representing the calculated histogram is smoothed at step S202. This makes it possible to apply a peak detection function to the signal. Indeed, in this embodiment, the histogram is decomposed into its wavelet coefficients using the Haar wavelet transform. The first approximation of this decomposed signal represents the overall shape of the original histogram and, provided the peaks are well separated, the peaks will also appear separated in the first approximation, as shown in FIGS. 4B and 4D.

Local maxima and minima searches are carried out to identify the threshold values. First, the searches are carried out on the smoothed signal at steps S203 and S204. If the two peaks do not separate or do not appear on the first approximation, the histogram signal is reconstructed using the first approximation and the first detail signals and the searches repeated on this reconstructed signal at steps S205 and S206. The reconstructed signal carries significantly more information about smaller peaks and the further local maxima and minima searches should therefore be successful. However, if the searches do not identify appropriate maxima and minima, the processor acquires a new image and calculates a new histogram and so on.

Assuming the maxima and minima searches find appropriate maxima and minima, these are used to determine three threshold values at step S207: a first threshold value TH1 is the maxima of the main peak of the histogram and corresponds with the iris mode value; a second threshold value TH2 is a minima on the less bright side of the main peak and corresponds to a minimum brightness for pixels belonging to the iris and a maximum value for pixels belonging to the pupil; and a third threshold value TH3 is a minima on the brighter side of the main peak and corresponds to a maximum brightness for pixels belonging to the iris and a minimum brightness for pixels belonging to the sclera.

In practice, in order to minimise the number of computations required, the histogram is calculated over a limited area of the image. The size of the area required can readily be determined by experimentation, but in order to achieve an accurate approximation of the threshold values, the area selected must include at least a part of the iris and at least a part of the pupil. In this embodiment, a frame 13 within the overall image 15 is used, as shown in FIG. 6. The use of the frame 13 also reduces the shadow effect 17 which is found mainly at the edges of the overall image. Depending on the expected size of the pupil, on the illumination and on the focal length of the camera, the area within the frame 13 can be reduced to up to 50 percent of the overall image.

Reducing the area of the image processed to the area within the frame 13 can be justified by the fact that, if the pupil is not within the area of the frame, part of the iris is likely to be outside the overall image and/or is likely not to be in focus. Consequently the code created would not be fully representative of the iris and a better result would probably be obtained by acquiring another image for processing.

A fine mesh scanning grid is drawn over the image within the frame 13 to facilitate location of the iris in the image using the determined threshold values. In order that a maximum number of pupil pixels are likely to be scanned, the grid has horizontal, vertical and diagonal lines. The number of lines employed in the grid can readily be determined by experimentation, but depends primarily on the expected size of the pupil, which in turn depends on the level of illumination and on the focal length of the camera.

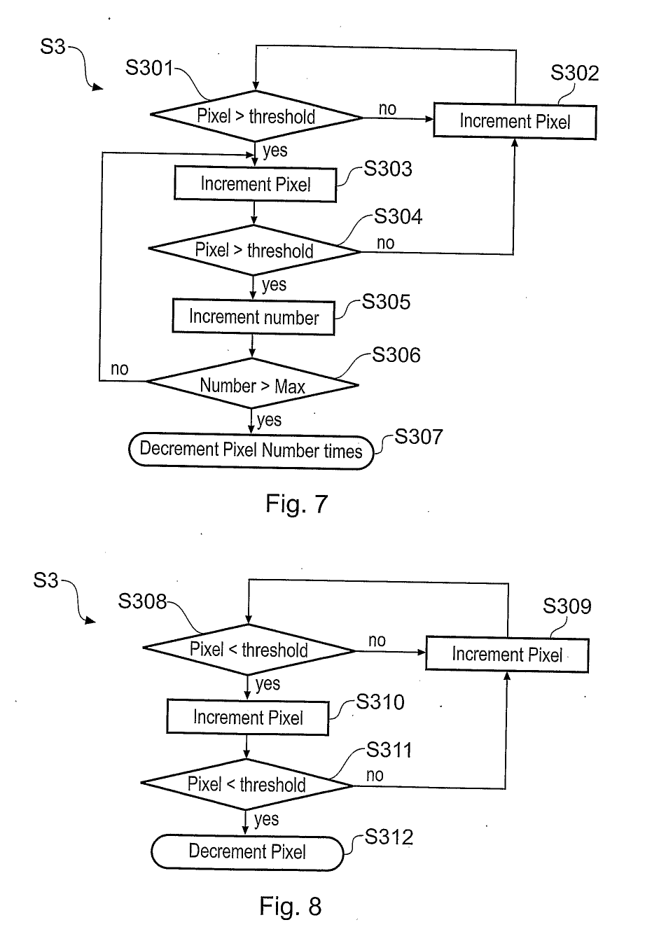

The pixels of each grid line are tested using the threshold, to identify the iris in the image. The testing is carried out on a pixel by pixel basis along the lines. Starting at an end of one of the lines, the first feature that is likely to be encountered is a shadow zone at the edge of the eye. Pixels in this shadow zone may have low values. So, as illustrated by the flow chart of FIG. 7, each pixel of a grid line is tested at step S301 against either the first threshold value TH1 or the third threshold value TH3, that is, the iris mode value or the maximum iris pixel value/minimum sclera pixel value. Either test should give effectively the same result, because both threshold values are used to determine the end of a shadow zone and the beginning of the sclera. If the value of the pixel is not above the chosen threshold value, the procedure moves to the next pixel at step S302 (if desired, to minimise the number of computations, the procedure may move on a predetermined number of pixels), which is again tested against the chosen threshold value at step S301. If the value of the pixel is above the chosen threshold value, the procedure still moves to the next pixel, this time at step S303, and that pixel is tested against the chosen threshold value at step S304. If the value of the pixel tested at step S304 is not above the chosen threshold value, the procedure moves to the next pixel and begins testing against the chosen threshold value, as before, at steps S302 and S301 respectively. If the value of the pixel tested at step S304 is above the chosen threshold value, the procedure counts that pixel at step S305 as being outside a shadow zone and continues to test the next pixel against the chosen threshold at steps S303 and S304. This results in either further pixels being counted as being outside a shadow zone or the procedure finding a pixel having a value below the chosen threshold value and the procedure returning to test a further pixel at steps S301 and S302. When a predetermined number of pixels are identified at step S306 as having been counted at step S305 to be outside of a shadow zone (i.e., greater than Max in FIG. 7), the pixel position is corrected at step S307 by decrementing the pixel number to identify the pixel at which the shadow zone was exited. The identified pixel, in practice, is located at the exit of a shadow zone along the grid line. In the event there should be no shadow zone, the pixel is decremented back to the beginning of the grid line. In any event, a start point for another scanning is identified either as the exit of the identified shadow zone or the beginning of the grid line (when there is no shadow zone).

Next, referring to FIG. 8, pixels along the grid lines after the start points are tested to establish whether they are within a dark zone that may be a pupil. More specifically, the pixel values are tested against the second threshold value TH2 at step S308. If the value of a pixel is not less than the second threshold value TH2 the procedure moves to the next pixel at step S309. If the value of the pixel is less than the second threshold value TH2, the procedure still moves on to the next pixel, this time at step S310, and the same test is repeated on the next pixel at step S311. If the value of this next pixel is again below the second threshold value TH2 (that is, there have been two consecutive pixels with values less than the second threshold value TH2) it is considered that the boundary of a dark zone has been detected. The pixel is then decremented at step S312 to return to the first pixel that was found to have a value below that of the second threshold TH2. This pixel is determined to be at the boundary of a dark zone that may be a pupil and is referred to below as an impact point.

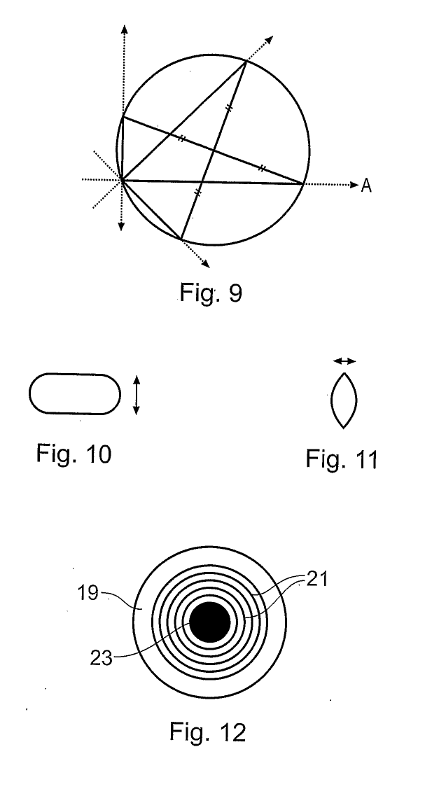

Once impact points have been determined for the various horizontal, vertical and diagonal grid lines, the next step (for a human eye) is to determine whether the impact points lie on the circumference of a circle. For each impact point, scans are conducted in four directions in order to determine four further points at which the scan lines intersect the boundary of the dark zone. Initially scanning continues in the original direction, for example direction A shown in FIG. 9 to identify a first further boundary point on the opposite side of the pupil. A second further boundary point is found by scanning from the impact point in a direction perpendicular to the original direction. The impact point, the first further boundary point and the second further boundary point create a right angle triangle. Third and fourth further boundary points are found by scanning in directions which are +/−45 degrees to the original direction. The impact point, the third further boundary point and the fourth further boundary point also create a right angle triangle.

If the impact point and the four further boundary points lie on a circle, the mid points of the longest side of each of the two triangles will coincide at the centre of the circle defining a dark zone corresponding to the pupil. Thus the procedure can identify two centre points for each impact point.

The use of a grid of appropriately sized mesh allows a substantial number of centre points to be identified. Statistical analysis is then employed to determine whether the centre points form the centre of a pupil. More specifically, centre points that are clearly incorrect are eliminated, while variance analysis is used, where the variance falls below a predetermined threshold, to calculate the mean of the centre points and thus to determine the centre of the pupil and thus to determine the centre of a circular area representing the pupil (and/or iris). The radius of the pupil (or the inner diameter of the iris) is found by statistical analysis of the distances between the centre and the impact points. If the variance of the distances is below a predetermined threshold (which can readily be determined by straightforward experiments) the average distance is taken to be the radius. Otherwise the set is reduced to too few values to produce a reliable result and a fail is returned and a new image is acquired.

A similar technique is used to determine the outer boundary of the iris (or the boundary between the iris and the sclera). Starting from the centre of the pupil, scanning lines are used to find the minimum and maximum distances between the centre and the edges of the iris using the average value of the iris mode value and the iris maximum value (i.e., the average value of the first threshold value TH1 and third threshold value TH3). In other embodiments, either one of these thresholds TH1, TH3 can be used themselves. Most points on the edge of the iris are found within +/−45 degrees of the horizontal due to the almond shape of the human eye and the presence of eyelids and/or eyelashes around the upper and lower parts of the image. A circle is drawn which represents the best fit with respect to the points found. These circular boundaries of the iris give the maximum and minimum radii of the area of the image in which the iris is found.

In the case of an animal iris the pupil is generally not of constant shape and is generally not circular. For example, FIG. 10 shows the shape of the pupil of a horse eye and FIG. 11 shows the shape of the pupil of a cat eye with the arrows indicating the direction of dilation in each case. Data (information) is extracted from the iris using different sized areas around the pupil. For example, the different sized areas can correspond to different pupil shapes that are found during dilation. Because an animal pupil is rarely symmetric in every direction, an elastic model can be used to create the iris information areas. Accurate determination of the threshold values TH1, TH2, TH3 as explained above allows the pupil shape in the original image to be matched with known base pupil shapes in the elastic model. The elastic model interpolates the base shape to a maximum pupil size, thus creating a number (typically 5 to 8) of concentric areas from which data can be extracted. The elastic model is based on a circle that can extend in one direction independently of other directions. The base pupil shape is determined by trial and error employing the threshold value between the iris and the pupil and employing the boundary points to fit to known pupil shapes. For example the pupil of a cat eye can be represented as a vertical ellipse and the procedure fits the boundary points around such an ellipse to determine the inner boundary of the iris. The outer boundary of the iris is assumed to be circular with the same centre of gravity as the inner boundary. The outer boundary of the iris is determined in the same manner as for a human eye, that is by determining a number of points on the outer boundary and employing a best fit procedure to fit the points on a circle.

Alternatively, a controllable illumination source can provide an image with an animal pupil of constant and controllable size and shape. The amount of light required can readily be determined by simple experimentation. This approach restricts the number of possible shapes when determining the best fit pupil/iris (inner) boundary. The inner boundary can then be approximated with great accuracy while optimising the number of boundary points and necessary computations. For example, a bright source of light will cause the pupil of a cat's eye to contract to a very thin ellipse. The procedure can then search only for pupil base shapes having a thin ellipse and the matching accuracy is significantly increased by reducing the range of possible shapes.

The procedure can additionally be used to check whether the images are of a live iris. This is accomplished by changing the intensity of the illumination and determining whether the size of the pupil varies accordingly. That is, a higher illumination intensity causes the size of the pupil to decrease and a lower intensity of illumination causes the size of the pupil to increase.

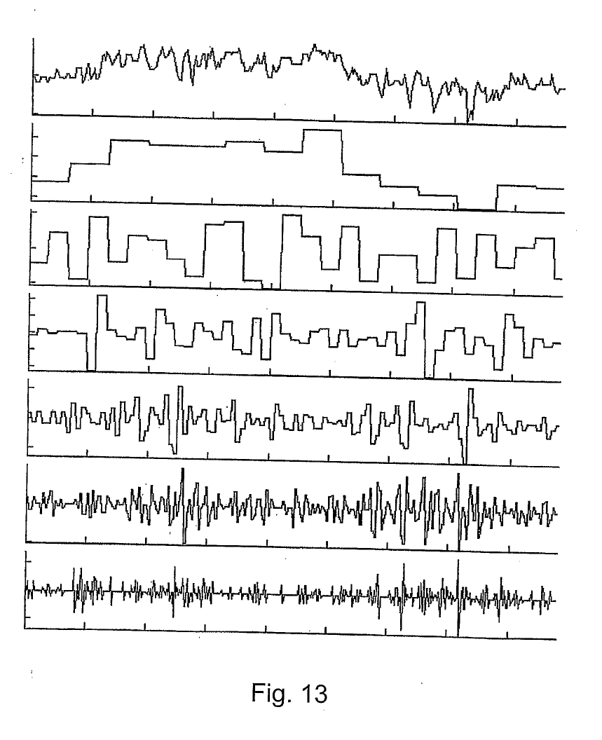

Referring to FIG. 12, one the area of the image that represents the iris has been identified, all or part of the iris area 19 is divided into a plurality of concentric zones 21 of variable width. The width of each band depends on the width of the iris area analysed and this, in turn, depends on the size of the pupil 23 (which is dependent, for example, on the level of illumination). Consequently, the procedure does not depend on radial scale. The zones are processed using a Haar wavelet filter as illustrated in FIG. 13. A Haar filter does not require substantial computing resources and allows filtering of high and low frequencies. The bands are then filtered along the width using an averaging filter, a Gaussian filter or a wavelet filter (such as a further Haar filter), to produce a one-dimensional signal.

Then each band is unwrapped using polar to Cartesian conversion and re-sampled to produce a signal of predetermined length. The re-sampling rate depends on the position of the respective band in relation to the others and not on the radius of that particular band and is determined experimentally as a result of previous experiments for each signal independently of its radius. In this way it is possible to compare each fixed-length band individually.

The re-sampled signal is then filtered along the length using wavelet filtering, i.e., the Haar filter, to produce a code representing the iris biometric data. The Haar filter eliminates components in the low frequencies and the high frequencies. The ideal extent of filtering can readily be determined experimentally. Each individual band may have different low and high levels. The biometric code is then created by reconstructing the signal using only the desired frequencies. FIG. 13 shows an example of an original signal and its decomposition into its Haar approximation and detail coefficients. In FIG. 13, the top line represents the original signal, the second line represents the approximation coefficients and the remaining five lines show, from top to bottom, low to high frequency detail coefficients.

As a result of potential inconsistencies, such as a reflection of the illumination source from the cornea, shadows and/or obstructions such as eyelids, the code created is a tri-state code in which the third state is used when data is not to be compared during authentication of the code. That is, as the iris data is scanned each pixel is tested against the maximum and minimum iris value previously calculated to detect potential inconsistencies caused by factors such as reflection of the illumination on the cornea and/or obstructions such as eyelids, eyelashes and shadows. These areas are not to be taken into account during the creation of the biometric code. For example, a large shadow zone located in approximately the same position in two separate eyes could significantly bias the final result towards a positive match. The statistical mean of the reconstructed code is 0 as the main DC term (approximation coefficient) is eliminated during wavelet filtering. The reconstructed code can then be transformed into a tri-state code where, for example, 0 corresponds to a negative sample, 1 corresponds to a positive sample, and 2 corresponds to an invalid sample (as explained above).

The codes created for each individual band are concatenated to produce a code specific to the iris contained in the image being analysed. For example, the iris can be divided into 8 bands, with each band creating a 256 bit signal, thus resulting in an overall signal length of 2048 bits by simple concatenation.

The concatenated code may be, for example, from 5 to 256 bytes in length. The code may be encoded into a solid state device, such as an RFID chip for physical transport and/or attached to an animal of item to authenticate ownership of the animal or item. Alternatively or additionally, the code can be transmitted to a database (in an encrypted form if transmitted over an unsecure network, such as a wireless telephone network). The code can be transformed into a hash function for storage in a database. Hashing is a one-way procedure which allows the comparison of two hashed codes, giving the same result as comparing the two original codes. It is possible to store the hashed codes in a non-secure manner, because the original codes cannot be recovered from their hash-transformed values.

The code can also be encoded into a 1- or 2-dimensional barcode, such as a data matrix, for printing purposes on a passport, an identity card or the like. The code can also be associated with a unique number stored into a database. The unique number would be generated upon registration and stored together with the code into the database. The unique number could then be printed on the passport, identity card or the like in the form of a 1- or 2-dimensional barcode. The authentication procedure would then be simplified as a single 1:1 iris code comparison would be performed between the unknown iris code and the code stored together with the unique number.

The iris biometric data can then be compared band by band with other data which may be stored in a local or a remote database.

The code representing the iris biometric data is authenticated, when required, by comparing the acquired code with a stored database of codes which have been created by the same procedure. The Hamming distance evaluates the number of identical values in the acquired code and the stored code using bitwise (generally XOR) operations.

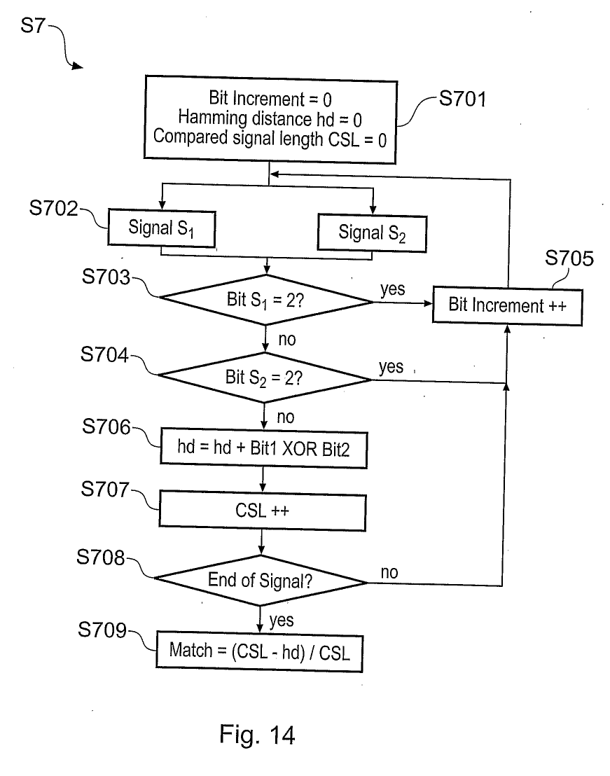

The Hamming distance between the codes is calculated over the length of the codes using the tri-state nature of the codes. When the third state is reached in either the acquired biometric code or the stored code, the Hamming distance is not calculated in order that only valid iris biometric data is compared. The procedure for calculating the Hamming distance is illustrated in FIG. 14. Parameters for the calculation are set in step S701. In steps S702 to S705, the Tri-state codes of sequential bits of two signals S₁ and S₂ are tested to check that they are not equal to 2 and hence invalid. Bits that are not invalid are then combined using an XOR function at step S706 and a counter incrementation (CSL operation) performed at step S707. This procedure continues until the end of the signals S₁ and S₂ as determined at step S708, when a final match operation is performed at step S709.

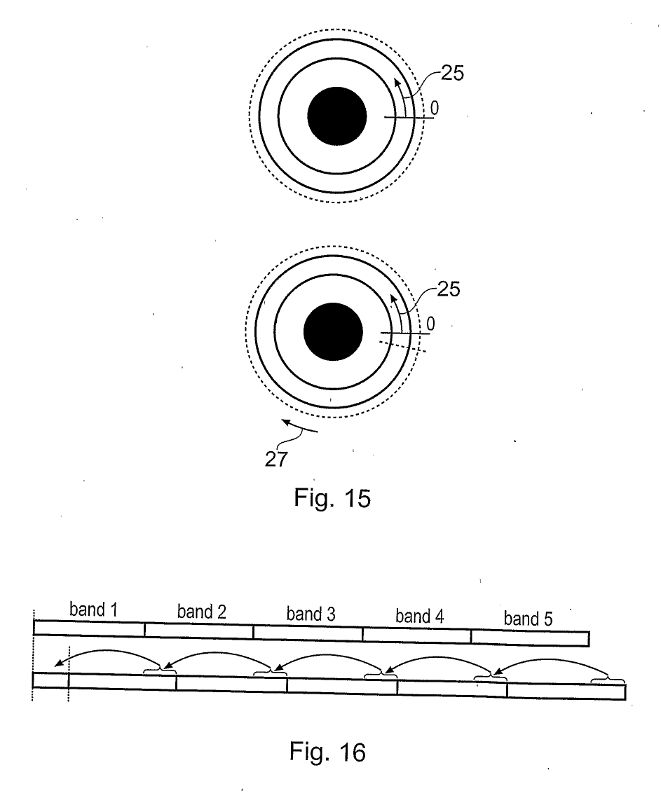

Because the original signal is based on a circular model, any in-plane rotation of the iris gives rise to a translational shift in the unwrapped signal as illustrated by FIG. 15 in which arrow 25 indicates the direction in which the code is unwrapped and arrow 27 indicates the direction of rotation of the eye. Consequently, a degree of rotational freedom in the code computation is permitted and is compensated for by introducing a translation factor into the initial position of the iris as illustrated with reference to FIG. 16. Any tilting of the iris image gives rise to a translational shift in the code as the iris signal is looping.

A percentage match is then calculated which allows the procedure to return a true or false result for the authenticity of the iris biometric data depending on whether the match is greater than a predetermined value. The predetermined value may be determined by experiment, but is generally of the order of 75 percent. The user can then be informed of the result of the identification by means of an audible and/or visible signal.

Of course, the described embodiments of the invention are only examples of how the invention may be implemented. Modifications, variations and changes to the described embodiments will occur to those having appropriate skills and knowledge.

For example, no stand-off cup 11 or LEDs 9 need be provided. In other embodiments, the stand-off cup 11 includes one or more lenses for optimising the size and focus of the subject's eye. Similarly, the inner surface of the stand-off cup 11 can be coated or otherwise provided with a non-reflective material to minimise reflections from the LEDs 9.

The LEDs 9 may emit radiation having a wavelength band anywhere in the visible, infra-red or ultra-violet regions of the spectrum. The camera 3 is then optimised for image capture in this wavelength band.

The white light of the LEDs 9 used in the illustrated embodiment, or LEDs 9 emitting light in some other particular visible part of the spectrum, can be used to control the size of the pupil of the subject. LEDs 9 that emit light that is not in the visible part of the spectrum can be used, together with an optical filter if appropriate, to enhance contrast between different parts of the image of the subject's eye, in particular between features of the iris.

In some embodiments, the display 5 can be used to display an image of the eye prior to image capture. The displayed image can then be used to position the eye correctly and ensure it is in focus before image capture.

These modifications, variations and changes may be made without departure from the spirit and scope of the invention defined in the claims and its equivalents.

1. A method of locating a boundary of an iris in a pixel-based image of an eye, the method comprising: comparing the values of each of a number of pixels along a plurality of lines across the image with a first threshold value in order to detect points along the lines at which the values of the pixels change to indicate the boundary of the iris of the eye; and locating the boundary on the basis of the detected points.

2. The method of claim 1, comprising: comparing the values of each of a number of pixels along a primary line across the image with the first threshold value in order to locate a primary point along the primary line at which the values of the pixels change to indicate the boundary of the iris of the eye; comparing the values of each of a number of pixels along a secondary line across the image with the first threshold value in order to locate a point along the secondary line at which the values of the pixels change to indicate the boundary of the iris of the eye; and locating the boundary on the basis of the detected primary and secondary points.

3. The method of claim 2, wherein the secondary line passes through the primary point.

4. The method of claim 2, wherein the secondary line is perpendicular to the primary line.

5. The method of claim 2, wherein secondary line is around 45 degrees to the primary line.

6. The method of claim 2, wherein multiple secondary points are detected using multiple secondary lines.

7. The method of claim 6, comprising verifying that the primary and secondary points reside substantially on a circle.

8. The method of claim 6, comprising identifying the centre of a circle defined by the primary and secondary points.

9. The method of claim 1 comprising locating another boundary of the iris by comparing the values of each of a number of pixels along a plurality of lines across the image with a second threshold value in order to detect points along the lines at which the values of the pixels change to indicate the boundary; and locating the boundary on the basis of the detected points.

10. The method of claim 1, wherein the first threshold value is a maximum value of the pupil.

11. The method of claim 9, wherein the second threshold value is a mode value for the iris.

12. The method of claim 9, wherein the second threshold value is a maximum value for the iris.

13. The method of claim 9, wherein the second threshold value is an average of a mode value for the iris and a maximum value for the iris.

14. The method of claim 1, comprising identifying a pixel along the lines at the exit of a shadow zone of the image by comparing the value of the pixels to a third threshold value and locating a start for the comparison to the first threshold value at the identified pixel.

15. The method of claim 14, wherein the third threshold value is a/the mode value for the iris.

16. The method of claim 14, wherein the third threshold is a/the maximum value for the iris.

17. The method of claim 1, comprising evaluating the image to determine the threshold value.

18. The method of claim 17, wherein the evaluation comprises determining the threshold value from a distribution of pixel values in at least part the image.

19. The method of claim 17, wherein the evaluation comprises calculating a histogram of pixel values for at least part of the image.

20. The method of claim 1, wherein values are levels of brightness.

21. The method of claim 1, comprising generating a code based on the appearance of the iris in the image by: identifying an area of the image representing the iris from the located boundary; generating a signal comprising values of a line of pixels extending around in a circumferential portion of the identified area; and applying a wavelet filter to the signal to generate a frequency limited code based on the appearance of the iris.

22. A method of generating a code based on the appearance of an iris in a pixel-based image of an eye, the method comprising: identifying an area of the image representing the iris; generating a signal comprising values of a line of pixels extending around in a circumferential portion of the identified area; and applying a wavelet filter to the signal to generate a frequency limited code based on the appearance of the iris.

23. The method of claim 22, wherein the wavelet filter is a Haar filter.

24. The method of claim 22, wherein the code is a Tri-state code in which one state represents and invalid section of the code.

25. An apparatus for locating a boundary of an iris in a pixel-based image of an eye, the apparatus comprising a processor that: compares the values of each of a number of pixels along a plurality of lines across the image with a first threshold value in order to detect points along the lines at which the values of the pixels change to indicate the boundary of the iris of the eye; and locates the boundary on the basis of the detected points.

26. The apparatus of claim 25, wherein the processor: compares the values of each of a number of pixels along a primary line across the image with the first threshold value in order to locate a primary point along the primary line at which the values of the pixels change to indicate the boundary of the iris of the eye; compares the values of each of a number of pixels along a secondary line across the image with the first threshold value in order to locate a point along the secondary line at which the values of the pixels change to indicate the boundary of the iris of the eye; and locates the boundary on the basis of the detected primary and secondary points

27. The apparatus of claim 26, wherein the secondary line passes through the primary point.

28. The apparatus of claim 26, wherein the secondary line is perpendicular to the primary line.

29. The apparatus of claim 26, wherein secondary line is around 45 degrees to the primary line.

30. The apparatus of claims 26, wherein the processor detects multiple secondary points using multiple secondary lines.

31. The apparatus of claim 30, wherein the processor verifies that the primary and secondary points reside substantially on a circle.

32. The apparatus of claim 30, comprising identifying the centre of a circle defined by the primary and secondary points.

33. The apparatus of claim 25, wherein the processor locates another boundary of the iris by comparing the values of each of a number of pixels along a plurality of lines across the image with a second threshold value in order to detect points along the lines at which the values of the pixels change to indicate the boundary; and locates the boundary on the basis of the detected points.

34. The apparatus of claim 25, wherein the first threshold value is a maximum value of the pupil.

35. The apparatus of claim 33, wherein the second threshold value is a mode value for the iris.

36. The apparatus of claim 33, wherein the second threshold value is a maximum value for the iris.

37. The apparatus of claim 33, wherein the second threshold value is an average of a mode value for the iris and a maximum value for the iris.

38. The apparatus of claim 25, wherein the processor identifies a pixel along the lines at an exit of a shadow zone of the image by comparing the values of the pixels to a third threshold value and locates a start for the comparison to the first threshold value at the identified pixel.

39. The apparatus of claim 38, wherein the third threshold value is a/the mode value for the iris.

40. The apparatus of claim 38, wherein the third threshold value is a/the maximum value for the iris.

41. The apparatus of claim 25, wherein the processor evaluates the image to determine the threshold value.

42. The apparatus of claim 41, wherein the evaluation comprises determining the threshold value from a distribution of pixel values in at least part the image.

43. The apparatus of claim 41, wherein the evaluation comprises calculating a histogram of pixel values for at least part of the image.

44. The apparatus of claim 25, wherein values are levels of brightness.

45. The apparatus of claim 25, wherein the processor generates a code based on the appearance of the iris in the image by: identifying an area of the image representing the iris from the located boundary; generating a signal comprising values of a line of pixels extending around in a circumferential portion of the identified area; and applying a wavelet filter to the signal to generate a frequency limited code based on the appearance of the iris.

46. An apparatus for generating a code based on the appearance of an iris in a pixel-based image of an eye, the apparatus comprising a processor that: identifies an area of the image representing the iris; generates a signal comprising values of a line of pixels extending around in a circumferential portion of the identified area; and applies a wavelet filter to the signal to generate a frequency limited code based on the appearance of the iris.

47. The apparatus of claim 46, wherein the wavelet filter is a Haar filter.

48. The apparatus of claim 46, wherein the code is a Tri-state code in which one state represents an invalid section of the code.

49. A method of processing a pixel-based image of an eye comprising the steps of: acquiring a pixel-based image of an eye; evaluating the image to determine thresholds representing features of the eye; scanning along a predetermined line and comparing with a first predetermined threshold so as to determine a first point at the boundary of the pupil; conducting further scans in a plurality of predetermined directions from the first point so as to determine a plurality of second points at the boundary of the pupil and the iris; identifying the centre of the pupil on the basis of the first and second points; scanning along a further predetermined line and comparing with a second predetermined threshold so as to determine a third point at the boundary of the iris and the sclera; and dividing the iris into a plurality of concentric zones and processing each zone in turn to produce a linear signal of predetermined length.

50. The method of claim 49, comprising evaluating the image to determine three thresholds, a first threshold representing the iris mode value, a second threshold representing a minimum value for the iris and a maximum value for the pupil, and a third threshold representing a maximum value for the iris and a minimum value for the sclera.

51. The method of claim 50, wherein the first predetermined threshold is the second threshold.

52. The method of claim 50, wherein the second predetermined threshold is the average value of the first and third thresholds.

53. The method of claim 50, wherein the image is evaluated with the aid of a histogram.

54. The method of claim 53, wherein the data in the histogram is smoothed by decomposing the histogram into its wavelet coefficients.

55. The method of claim 50, comprising the further step of determining, prior to determining the first point, whether a pixel has a value above a third predetermined threshold, moving to the next pixel if the value is not above the third predetermined threshold and repeating the test, moving to the next pixel if the value is above the third predetermined threshold and determining whether a predetermined number of sequential pixels are above the third predetermined threshold so as to establish whether any shadow zone has been exited.

56. The method of claim 55, wherein the third predetermined threshold is the first or the third threshold.

57. The method of claim 49, wherein scanning for the determination of the first point is conducted in relation to a grid pattern, the grid pattern having horizontal, vertical and diagonal lines.

58. The method of claim 50, wherein the step of scanning for the first point comprises comparing with the first predetermined threshold and, if the pixel has a value not less than the first predetermined threshold, moving to the next pixel, and, if the pixel has a value less than the first predetermined threshold, moving to the next pixel and determining that the boundary of the pupil has been located if the next pixel also has a value less than the first predetermined threshold.

59. The method of claim 58, wherein the first predetermined threshold is the second threshold.

60. The method of claim 49, wherein the step of scanning for the first point includes scanning for a plurality of first points.

61. The method of claim 60, wherein the further scans may be conducted for each first point.

62. The method of claim 49, wherein the further scan(s) may be conducted in four directions.

63. The method of claim 62, wherein the four directions are horizontal, vertical and +/−45 degrees to the horizontal (or vertical).

64. The method of claim 49, wherein the further predetermined line starts from the centre of the pupil.

65. The method of claim 49, wherein a plurality of further predetermined lines are scanned and the edge of the iris is determined by a best fit circle through the corresponding third points.

66. The method of claim 49, wherein, in the event the iris is not annular, the first, second and third points are compared with stored data and the determined data may be translated to equate to a substantially annular form for dividing into a plurality of concentric zones.

67. The method of claim 49, wherein the concentric zones are processed with a wavelet filter.

68. The method of claim 49, wherein the concentric zones are processed with a Haar wavelet filter.

69. The method of claim 67, wherein the concentric zones are then processed with an averaging filter, a Gaussian filter or a wavelet filter, such as a further Haar filter, to produce a one-dimensional signal.

70. The method of claim 69, wherein the signal from each concentric zone is then resampled to produce a signal of predetermined length and the resampled signal may be filtered along its length with a wavelet filter, such as a Haar filter, to produce a biometric code.

71. The method of claim 70, wherein the biometric code is a tri-state code incorporating a third state representing data that is not to be used during authentication.

72. The method of claim 70, wherein the biometric code is converted into a hash function.

73. Computer software adapted to carry out the method of claim 49 when processed on computer processing means.

74. An apparatus for processing a pixel-based image of an eye comprising means for: acquiring a pixel-based image of an eye; evaluating the image to determine thresholds representing features of the eye; scanning along a predetermined line and comparing with a first predetermined threshold so as to determine a first point at the boundary of the pupil; conducting further scans in a plurality of predetermined directions from the first point so as to determine a plurality of second points at the boundary of the pupil and the iris; identifying the centre of the pupil on the basis of the first and second points; scanning along a further predetermined line and comparing with a second predetermined threshold so as to determine a third point at the boundary of the iris and the sclera; and dividing the iris into a plurality of concentric zones and processing each zone in turn to produce a linear signal of predetermined length.

75.-81. (canceled)
